(19) United States
(12) Patent Application Publication
(10) Pub. No.: US 2006/0143048 A1
(43) Pub. Date: Jun. 29, 2006

(54) System for individual healthcare information

(76) Inventor: Torbjorn Fryklund, Harnosand (SE)

Correspondence Address: YOUNG & THOMPSON, 745 SOUTH 23RD STREET, 2ND FLOOR, ARLINGTON, VA, 22202, US

(21) Appl. No.: 11/022,632

(22) Filed: Dec. 28, 2004

(51) Int. Cl. G06F 19/00

(52) U.S. Cl. 705/3

(57) ABSTRACT

The present invention discloses a medical information system comprising a main database comprising standardized diagnosis and treatment information regarding medical conditions, at least one affiliated database comprising customized diagnosis and treatment information regarding medical conditions, and a health care provider user interface for accessing said databases, arranged to allow a health care provider to select the standardized or customized diagnosis and treatment information for a given medical condition, to edit the diagnosis and treatment information, to save the edited information as customized information in at least one of the affiliated databases, and to forward the edited information to an information receiver as personal healthcare report. The invention further comprises a method and a tool.

### FIELD OF THE INVENTION

The present invention relates to a medical information system for providing a personal healthcare report (PER).

### BACKGROUND OF THE INVENTION

It is a well known problem for any healthcare provider such as a physician or a dentist, to in a short time, give a patient an adequate information about his/her diagnosis as well as its background and causes, planned and alternative treatment, prognosis, costs etc.

The reason for the problem is often lack of time, the mental blockage of the patient that almost always occurs in the medical consultation situation, language difficulties (from both the doctors/dentists and patients point of view), intellectual status and age of the patient. Often relatives or the partner have questions later on which have not been discussed during the visit at the doctor/dentist.

The lack of information results in huge extra and unnecessary costs for the healthcare system because of unnecessary extra visits, telephone calls and even mistreatment and possible summon. For the patient it also results in added discomfort, dissatisfaction and lack of trust in the healthcare provider.

The most common way for a physician or a dentist to inform a patient is to give all the information verbally. Problems connected with this is mentioned above.

Printed documents and brochures about a certain disease and treatment can be handed out by the healthcare provider. These are mostly general information and not locally adapted for the clinic or hospital, or individually adapted to the patient and does not take into consideration other diseases, treatments or the general health status of the patient.

General medical information texts and ways of treatment are seldom updated. They are therefore mostly regarded as uninteresting and non-personal to the patients and physicians/dentists, especially because of lack of personal instructions regarding treatments, return visits, instructions, and name of the treating and responsible physician or dentist with telephone number and telephone hours.

There are sites available on the internet where the patient outside the clinic or hospital can find information regarding a diagnosis but without adaptation to his/her personal situation. These public healthcare sites use standard texts exclusively which cannot be edited or changed, and consequently cannot be adapted to customized versions. Further, these public healthcare sites provides no individualized information such as next visit, pictures related to the individual diagnosis and relevant contact information.

In the U.S. Pat. No. 6,014,630 a system for producing individualised patient educational reports for patients about to receive surgery is disclosed. The report advices the patient what to anticipate and what is expected of him.

### SUMMARY OF THE INVENTION

The object of the invention is to provide a new system, method and tool for providing individual medical information and instructions to an information receiver, such as a patient, which overcomes one or more drawbacks of the prior art.

This is achieved by the medical information system as defined in claim 1, the method for providing medical information as defined in claim 15 and the tool for providing said information as defined in claim 16.

One advantage with the medical information system according to the present invention is that it allows a healthcare provider to rapidly provide highly personalized medical information comprising diagnosis and treatment information.

Another advantage is that the information provided by the system can be edited in order to be adapted to the patient's personal situation, intellectual status, mother language, etc.

The invention is a flexible database system for providing individual diagnosis and treatment information from a healthcare provider to an information receiver such as a patient.

Throughout this description, the term “healthcare organisation” is meant any private and/or public healthcare institutions e.g. hospitals, veterinarian clinics, and optician/physiotherapist offices, as well as county councils, national healthcare organisations and authorities.

The term “healthcare provider” refers to any person in a healthcare organisation or at a single person practice, in position to give medical information or advices to an information receiver. Examples of healthcare providers are: physicians, dentists, veterinarians, opticians and physiotherapists.

The term “information receiver” may refer directly to the patient, but also to other persons such as family members, partners, relatives and animal owners.

The term “diagnosis” is defined as described in the Mosby's Medical & Nursing Dictionary, that is, “identification of a disease or condition by a scientific evaluation of physical signs, symptoms, history, laboratory tests and procedures”.

The term “treatment” is defined as described in the Mosby's Medical & Nursing Dictionary, that is, “the care and management of a patient in order to combat, ameliorate, or prevent a disease, disorder, or injury”.

The unique features if the invention compared with prior art public healthcare databases are;

The healthcare provider can adapt and develop a text based on standard texts, i.e. texts available in the database.

The healthcare provider can easily tailor information for each personal medical information by e.g.:

Edit, delete or add text

Place text related to different treatment alternatives under separate headings for planned or alternative treatment

Add, delete or exchange images

Insert a custom price list for treatments

Embodiments of the invention are defined in the dependent claims.

### BRIEF DESCRIPTION OF THE DRAWINGS

FIG. 1 shows a schematic view of one embodiment of a medical information system according to the present invention.

FIG. 2 schematically shows one example of an operation procedure for providing medical information through the system.

FIG. 3 shows an example of a personal healthcare report (PHR).

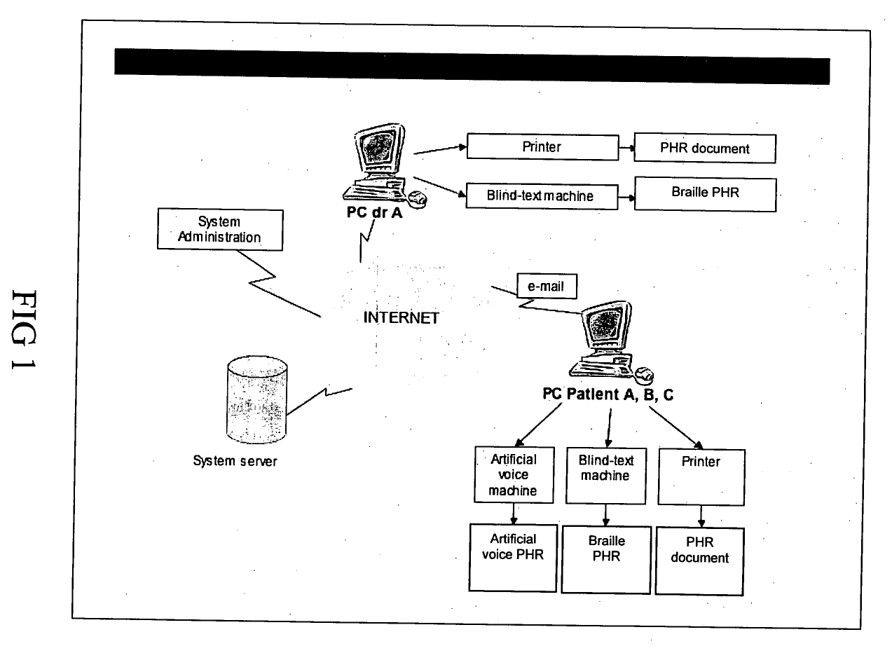

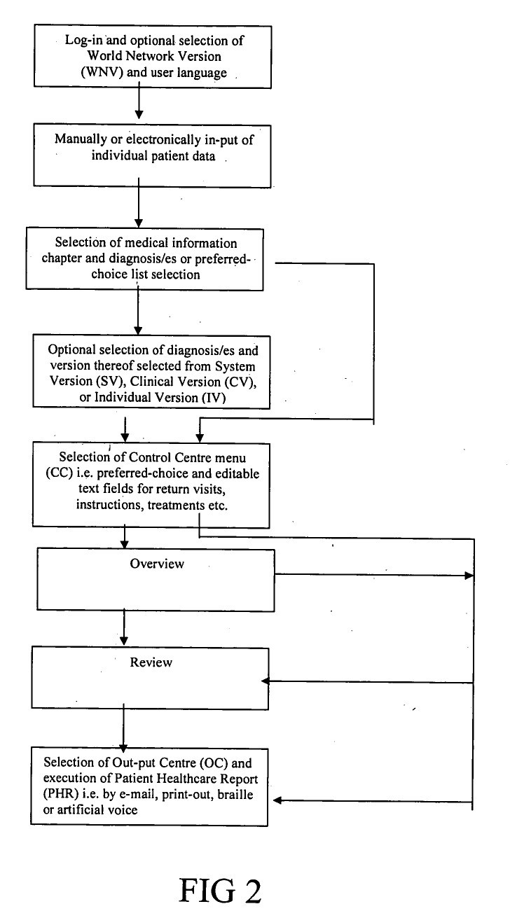

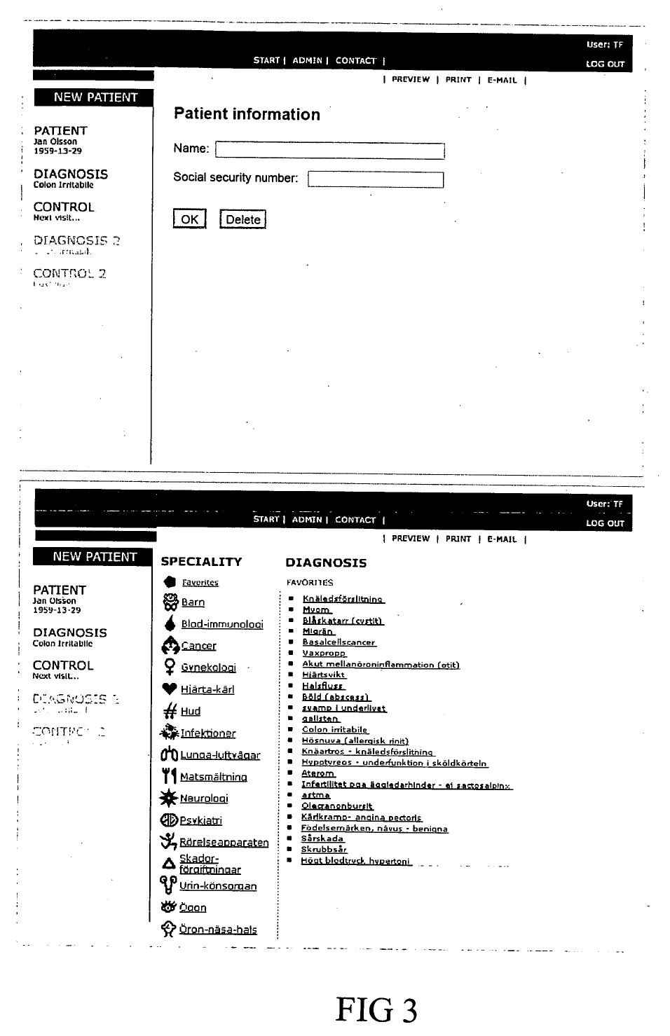

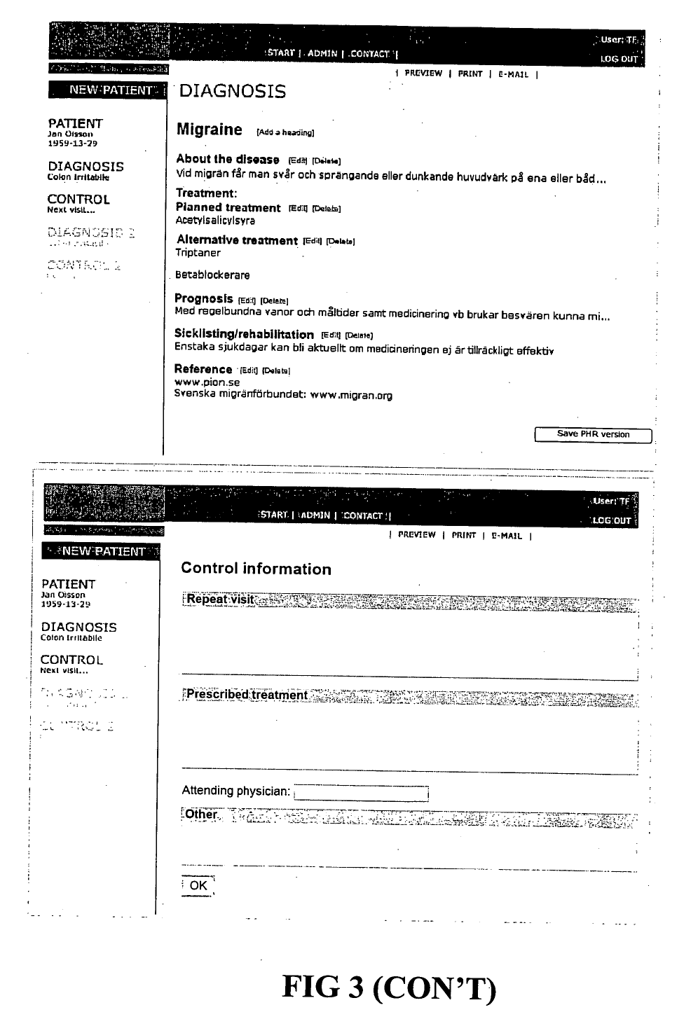

### DETAILED DESCRIPTION OF THE INVENTION

A first embodiment of the present invention relates to a medical information system allowing a healthcare provider to rapidly provide personalized medical information comprising diagnosis and treatment information, by selecting appropriate diagnosis and treatment information from one or more databases and thereafter if necessary edit said information. The medical information system comprises, a main database that comprises standardized diagnosis and treatment information regarding medical conditions, at least one affiliated database comprising customized diagnosis and treatment information regarding medical conditions, and a healthcare provider user interface for accessing said databases.

According to one embodiment, the content in the main database is provided and continuously updated by a system supplier. The system supplier can be a commercial company supplying the system to healthcare providers or organizations, nationally or world wide. Alternatively, the system supplier can be a national or regional healthcare authority or the like, whereby the diagnosis and treatment information can be used as an instrument to provide treatment guidelines and recommendations through-out the national or regional healthcare organisations.

According to one embodiment, the medical information system according to the present invention comprises at least one affiliated database in the form of a healthcare provider database, wherein each healthcare provider may save any customized diagnosis and treatment information. The saved information is linked to a medical condition and will be available for subsequent use, as an alternative to the standard information from main database. In addition to or in lieu of the healthcare provider database, the system may comprise an affiliated healthcare organisation database, containing customized diagnosis and treatment information in accordance with local guidelines, recommendations, preferences or the like. As an example, the healthcare organisation database can be used to promote prescription of less expensive treatments when there are several equivalent choices, etc.

The databases may either be provided locally, on one or more central server(s), or at a combination thereof.

According to one embodiment, discussed in detail below, the user interface is a graphical interface with roll down menus, pop-up buttons etc. However, the interface can also be a voice controlled interface or a combination thereof. The user interface is arranged to allow a healthcare provider, to select the standardized or customized diagnosis and treatment information for a medical condition. The selection of diagnosis and treatment information is performed by the healthcare provider, based on the characteristics of the medical condition, personal experience, the information receiver status etc. in order to select the most appropriate information for each patient and situation. In order to adapt the information even more to each patient and situation, the user interface allows the healthcare provider to edit the selected diagnosis and treatment information. Hereby, it is possible to create specially adapted information, for each healthcare situation, including rare medical conditions, combinations of medical conditions etc. in an efficient way. The healthcare organisation or healthcare provider may easily supplement the stock of standard texts with more diagnoses, more treatments, more texts related to return visits, etc. Pictures related to the medical condition may be attached to the text document. Moreover, the adaptation of the information retrieved from the databases may involve, adaptation to the patient's mental state, ethnic belonging, educational level etc, all based on the judgement of the healthcare provider, and which cannot be supported directly by the contents in a database. In order for the healthcare provider to reuse such adapted or customized diagnosis and treatment information, the user interface is arranged to allow the healthcare provider to save the edited information as customized information in at least one of the affiliated databases discussed above.

Each individual healthcare provider may store his/her own versions that only he/she has access to, or he/she may allow access for other healthcare providers, e.g. within the same organisation. The healthcare organisation may also provide the name of the healthcare provider responsible for the patient, taken from the organisation list of healthcare providers.

Output information from the medical information system is referred to as personal medical information, and is prepared in the user interface and forwarded to the information receiver in a desirable format. Possible content in and format of the personal medical information is discussed in detail below.

This medical information system provides a standardized and/or customized diagnosis and treatment information for a medical condition comprising a number of treatment information alternatives that may be selected individually or as a group. In order to secure the secrecy of the personal information, it is not possible to store personal information neither in the main diagnosis and treatment information database nor in the affiliated diagnosis and treatment information database(s).

The medical information system may be a system wherein the user interface for the health care provider alerts the health care provider i.e. by differently coloured characters or signs, about updates of information in the database(s).

The user interface for the healthcare provider accessing the databases, can be arranged to allow a healthcare provider to add patient data to the personal medical information by retrieving data from local patient database, and/or electronic patient journal. The personal medical information may include information about two or more related or separate medical conditions. The user interface for the healthcare provider accessing said databases, can be arranged to allow a healthcare provider to add care provider contact data, return visit information, and further references to the personal medical information. Personal medical information can include information on visits (date for next visit, which healthcare provider to visit) as well as contact information (reception name, address, telephone number, telephone hours, e-mail address). The personal medical information may also comprise a formal prescription and/or referral form.

The personal medical information can be forwarded to the information receiver as a printed document, e-mail, braille, and/or a verbal message from an artificial voice machine.

The diagnosis and treatment information regarding a medical condition in the personal medical information can be provided in language other than a default language of the medical information system.

The medical information system further comprises a user interface for medical care provider allowing said care provider to edit the customized diagnosis and treatment information in the affiliated healthcare organisation database.

In as second aspect, the invention also disclosed a method for providing personal medical information comprising the steps:

providing a main database comprising standardized diagnosis and treatment information regarding medical conditions,

providing at least one affiliated database comprising customized diagnosis and treatment information regarding medical conditions,

providing a user interface for healthcare provider accessing said databases, allowing a health care provider to provide personal medical information by: selecting the standardized or customized diagnosis and treatment information for a given medical condition,

editing the diagnosis and treatment information,

saving the edited information as customized information in at least one of the affiliated databases, and

forwarding the edited information to an information receiver as personal medical information.

In a third aspect, the invention further disclosed a tool for providing personal medical information comprising an interface for selecting diagnosis and treatment information for a given medical condition, from a main database comprising standardized diagnosis and treatment information and/or at least one affiliated database comprising customized diagnosis and treatment information regarding medical conditions,

editing the diagnosis and treatment information,

saving the edited information as customized information in at least one of the affiliated databases, and

forwarding the edited information to an information receiver as personal medical information.

The tool may further comprise means for importing personal information from patient database and/or electronic journal, as well as means for editing, storing and forwarding personal medical information.

The product of the system is the information forwarded from a health care provider to an information receiver, called Personal Healthcare Report (PHR). The PHR comprises diagnosis and treatment information for a given medical condition selected from a main database comprising standardized diagnosis and treatment information and/or at least one affiliated database comprising customized diagnosis and treatment information regarding medical conditions, wherein the diagnosis and treatment information is edited by the health care provider. The PHR may further comprise clinic/hospital/office data such as name, address etc, name and security number of the patient, name of the treating healthcare provider at the latest visit, date of the visit, name of the responsible healthcare provider and his/her contact data, name of the diagnosis/es and corresponding description i.e. background of the disease, treatment and alterative treatment(s), prognosis, sick-leave period, next visit, certain treatment recommendations i.e. texts, pictures, films, self medication advice, references to web-pages, diagnosis-related pictures/films etc., and signature of treating healthcare provider. The invention provides a personal document that can be signed, printed out by a doctor or other healthcare personnel. The PHR can be sent by e-mail. The information can be transferred or stored in a clinical journal, be it a paper journal or a digital journal.

Detailed Example of One Embodiment

In this detailed example a system comprising a World Network Version (WNV) is described. During the medical consultation situation when a patient is to be provided with information of one or several diagnosis/es, treatment schedule and other relevant health-related information, the health care provider responsible for treating the patient log-in to the network.

The healthcare provider may from the start menu select the country/language of interest from the WNV of the system, if another than the logged in version is desired. In the WNV are the text-fields, especially the ones for planned and alternative forms of treatment, nationally adapted. The WNV makes it possible for a healthcare provider to read and work in the system in any language, independently of from where he/she is working geographically. The name and the social security number of the patient is typed into the start menu or transferred from an electronic journal.

The healthcare provider controls the diagnosis information. (The system assumes that the examinations and medical tests have been performed and have lead to one or several diagnosis/es.). This is performed by first selecting the relevant medical chapter in the menu of the system and then the diagnosis or its corresponding diagnosis number. It may also be performed by selection from a preferred-choice list presenting the most common diagnoses set by the healthcare provider. Each healthcare provider automatically creates his/her own personal list of preferred-choices containing a list of diagnoses. The preferred-choice list functions as a short-cut when the user creates a PHR. This PHR document may be transformed to a braille or a verbal message.

The healthcare provider may among the diagnoses, select either the System Version (SV) of the basic information delivered by the system, the Clinical Version (CV) which comprises adaptations made locally at the clinic/healthcare organization, or an Individual Version (IV) which comprises changes made by a healthcare provider for his own purposes in the selected diagnosis and its related information-texts. Suggested text can be attached to this section of the diagnostic descriptions in the SV, in the CV and in the health care provider's own version. This information is easily edited and adapted for each PHR, as all other information.

Behind the name of the diagnosis and the edition of the description, there is a date showing when the text has been updated by which the user interface for the healthcare provider alerts the healthcare provider about updates of information in the database(s).

A Main System Administrator (MSA) can make registrations in WNV and CV. Registrations in the CV can only be performed by a System Administrator (SA) within the health care organization. Registrations in the IV can be performed by a person having general access to the system. The IV is not accessible to anyone else at the clinic but the person making the registration.

The system provides the PHR that comprises a selected group of answers to the internationally most common questions asked by patients at the time when the diagnosis is given together with treatment alternatives. The questions and answers are selected from international literature, personal experience as a skilled person in the art, and through discussions with healthcare colleagues. The flexible structure of the system comprising stored medical information texts, pictures, video files, treatment alternatives, and other data, where all information can temporarily be modified or removed before presented to the individual patient, or locally stored as a CV by the SA.

The system provides basic information which continuously is updated by the medical information system provider, but each healthcare organization or individual healthcare provider can change the content in all available texts individually, and by working with the easy-to-use text editor built into the program also save this text as a template. Particular routines for return visits, prognosis etc. may vary and this function makes the system unique and different from other healthcare information systems accessible by internet. Some diagnoses are provided with pictures which refer to the medical condition. The healthcare provider may also select an image from his/hers picture archive and attach it to the print-out made in the consulting room and present it directly to the patient. It can also be stored combined with the diagnosis for further use on the system server. Advertisements, banners etc. may also be exposed on the screen. The health care provider is directly responsible for the content of the texts.

The system texts are built up by a group of Standard Headings (SH), which in the Maintenance Menu (MM) may be changed and stored in the System Server (SS) for each healthcare organization.

Individual patient information is not stored in this system server.

After selecting the relevant diagnosis the healthcare provider enters in the Control Center menu (CC), a menu with preferred-choices and editable text fields for:

Planned and alternative forms of treatment. A standard treatment may be selected locally for the healthcare organization.

This is a menu in which one easily may select type of treatment for a specific patient. All other suggested treatments may with a preferred-choice function be classified in the text as alternative forms of treatment or be excluded. It is always possible to type another text with the text editor to the individual patient and to print it out. It is also possible to store this text on the system server for further use.

Time for return visits and check-ups are selected with a preferred-choice menu with alternatives of return visits and check-ups, even exact date and time which may be integrated with a visiting system of the clinic. A Standard Value for each diagnosis or treatment may be made and stored on the system server.

Special instructions. A field with specific text regarding appropriate measurement values to be determined in connection with treatment of the disease. A CV for each diagnosis or treatment may be made and stored on the system server.

The system contains an archive of images/video files for an anatomical description of the medical condition, as well as dental images. An image can be attached to any text section in the system.

General Information field (GI). An “open” text field which may be used for general information of the disease or other practical information which may be generated locally and/or centrally. Costs of treatment etc. may also be included.

A combination of speed and individual adaptation of the system is unique and has not previously been found in any healthcare system. The preferred-choice functions make the system user-friendly and easy to use from i.e. a portable computer where the information is transferred to the Out-put Centre (OC) of the system.

Responsible healthcare provider of the patient, may be selected from the preferred-choice menu if it is not the same as the person which the patient meets during the visit. Contact data to responsible health care provider may be included in the PHR document with name, address, telephone number, e-mail etc.

Choice of language. If the patient is a foreigner with poor language skills, it is possible to select the patients mother language and the program may make the print-out in the selected language (customized and changed versions cannot be printed out in other languages). The choice of language may be done from the Control Center menu (CC). The need for an interpreter or risk for misunderstandings is avoided by the possibility to select language.

The patient receives a PHR printed out through the system at the clinic. The document may also be printed out at a later date and sent by postal service or e-mail using the mail function in the system.

From the CC it is possible to go to:

Overview is a menu with a shorter version of the PHR-document.

Review is a menu with the complete version of the PHR document as it may be presented in the print-out to the patient.

Out-put Centre (OC) is a menu from where the healthcare provider selects how to present the PHR document:

With a printer as a paper document to the patient.

With a printer as a paper document by a special blind-text machine to a braille to the patient.

As an e-mail to the patient or another treating healthcare provider.

As an e-mail to the patient and read with a artificial voice of an special voice machine.

Save a copy of the PHR document to the electronic journal of the clinic/hospital/office.

Save a paper copy of the PHR document in the hospital/clinic/office journal system if paper journals are used.

The Maintenance Menu (MM) may be accessed in the system by the local SA.

In the MM it is possible to perform local changes of the:

Diagnosis, SH, treatments, special instructions and return visits.

The SA may in System Menu (SM) delete or give access to new co-workers in the clinic/hospital/office with name, contact data etc. The SA may also elect local treatment strategies and recommendations without changing the text in the medical database. This presents a unique possibility to select choice of medication or treatment based on economical and/or patient safety reasons. This feature of the system is especially important for newly employed personnel. The system also provides a possibility to add local information, educational information for the personnel and/or advertisement that are not accessible for the patient in the PHR.

Content of a Example PHR

Logotype of the hospital/clinic/office, address, e-mail address, web-page and telephone number.

Name and social security number of the patient.

Name of healthcare provider at the visit.

Date of visit.

Name of responsible healthcare provider (if other than the one at the visit) and his/hers contact data (address, telephone number, telephone time, e-mail address).

Name of diagnosis/es

Example of headings of diagnosis and corresponding medical text:
Background of the medical condition
Treatment and alternative treatment
Prognosis
If possible, length of sick-leave
Return visit, approximate or definite date and time
Possible special instructions, information texts and/or images/video films.
Possible self-medication.
Further general information via editing fields.
References, web-pages
Possible pictures/video films connected to the diagnosis

Signature of treating health care provider

1. Medical information system comprising
a main database comprising standardized diagnosis and treatment information regarding medical conditions,
at least one affiliated database comprising customized diagnosis and treatment information regarding medical conditions, and
a healthcare provider user interface for accessing said databases, arranged to allow a health care provider
to select the standardized or customized diagnosis and treatment information for a given medical condition,
to edit the diagnosis and treatment information,
to save the edited information as customized information in at least one of the affiliated databases, and
to forward the edited information to an information receiver as personal healthcare report.

2. Medical information system according to claim 1 comprising an affiliated healthcare organisation database comprising diagnosis and treatment information regarding medical conditions customized by said healthcare organisation.

3. Medical information system according to claim 1 comprising an affiliated health care provider database comprising diagnosis and treatment information regarding medical conditions customized by said healthcare provider.

4. Medical information system according to claim 1 wherein the standardized and/or customized diagnosis and treatment information for a given medical condition comprises a number of treatment information alternatives that can be selected individually or as a group.

5. Medical information system according to claim 1 is arranged so that personal information not can be stored in the main diagnosis and treatment information database.

6. Medical information system according to claim 1 is arranged so that personal information not can be stored in the affiliated diagnosis and treatment information database(s).

7. Medical information system according to claim 1 wherein the user interface for the healthcare provider alerts the healthcare provider about updates of information in the database(s).

8. Medical information system according to claim 1 wherein the user interface for the healthcare provider accessing said databases, is arranged to allow a healthcare provider to add patient data to the personal medical information by retrieving data from local patient database, and or electronic patient journal.

9. Medical information system according to claim 1 wherein the personal medical information comprises a formal prescription and/or referral form.

10. Medical information system according to claim 1 wherein the user interface for the healthcare provider accessing said databases, is arranged to allow a healthcare provider to add care provider contact data, return visit information, and further references to the personal healthcare report.

11. Medical information system according to claim 1 wherein the personal healthcare report may be forwarded to the information receiver as a printed document, e-mail, braille, and/or a verbal message from an artificial voice machine.

12. Medical information system according to claim 1 wherein the diagnosis and treatment information regarding a medical condition in the personal healthcare report may be provided in language other than a default language of the medical information system.

13. Medical information system according to claim 1 wherein the personal healthcare report may include information about two or more related or separate medical conditions.

14. Medical information system according to claim 2 further comprising a user interface for healthcare organisation allowing said organisation to edit the customized diagnosis and treatment information in the affiliated health care provider database.

15. Method of providing personal medical information comprising the steps:
providing a main database comprising standardized diagnosis and treatment information regarding medical conditions,
providing at least one affiliated database comprising customized diagnosis and treatment information regarding medical conditions,
providing a user interface for healthcare provider accessing said databases, allowing a healthcare provider to provide personal medical information by:
selecting the standardized or customized diagnosis and treatment information for a given medical condition,
editing the diagnosis and treatment information,
saving the edited information as customized information in at least one of the affiliated databases, and
forwarding the edited information to an information receiver as personal medical information.

16. A tool for providing personal medical information comprising an interface for:
selecting diagnosis and treatment information for a given medical condition, from a main database comprising standardized diagnosis and treatment information and/or at least one affiliated database comprising customized diagnosis and treatment information regarding medical conditions
editing the diagnosis and treatment information,
saving the edited information as customized information in at least one of the affiliated databases, and
forwarding the edited information to an information receiver as personal medical information.

17. A tool according to claim 16 comprising means for importing personal information from patient database and/or electronic journal.

18. A tool according to claim 17 further comprising means for editing, storing and forwarding personal medical information.

19. Personal medical information forwarded from a health care provider, comprising diagnosis and treatment information for a given medical condition, selected from a main database comprising standardized diagnosis and treatment information and/or at least one affiliated database comprising customized diagnosis and treatment information regarding medical conditions, wherein the diagnosis and treatment information is edited by the health care provider.
